(19) United States
(12) Patent Application Publication
(10) Pub. No.: US 2018/0340071 A1
(43) Pub. Date: Nov. 29, 2018

(54) Treatment of vanadium yellow pigments with carbohydrate-based syndets to improve ion resistance in an alkaline medium

(71) Applicant: Evonik Degussa GmbH, Essen (DE)

(72) Inventors: Pedro Cavaleiro, Viersen (DE); Matthias Bouwman, Duesseldorf (DE); Pascal Senter, Duisburg (DE)

(73) Assignee: Evonik Degussa GmbH, Essen (DE)

(21) Appl. No.: 15/954,529

(22) Filed: Apr. 16, 2018

(30) Foreign Application Priority Data
May 23, 2017 (EP) 17172440.4

(51) Int. Cl. C09C 1/00; C09C 3/10

(52) U.S. Cl. CPC C09C 1/0006; C01P 2006/62; C01P 2004/51; C09C 3/10

(57) ABSTRACT

A composition can exhibit improved ion resistance and color stability. The composition includes a pigment made of bismuth vanadate (BiVO₄). The pigment is in the form of particles coated with at least one O-functionalized carbohydrate, where the O-functionalized carbohydrate is at least one of an ether of a carbohydrate and an ester of a carbohydrate. The carbohydrate is at least one of a monosaccharide and an oligosaccharide. The oligosaccharide is at least one of an oligosaccharide having two to ten monosaccharides, a sugar alcohol, a sugar acid, and a lactone of the sugar acid.

The invention provides compositions comprising vanadium yellow pigments which have been coated with carbohydrate-based syndets and have improved ion resistance. The invention further provides for the use of carbohydrate-based syndets for this purpose, and also provides compositions comprising particulate pigments containing bismuth vanadate (BiVO₄) that have been coated with O-functionalized carbohydrates or mixtures of O-functionalized carbohydrates. The carbohydrate here forms the glycone and, preferably, a fatty alcohol or a fatty acid forms the aglycone in the O-functionalized carbohydrate.

The O-functionalized carbohydrates are referred to as syndets and improve the colour stability of the bismuth vanadate-containing pigments to ionic influences, such as alkaline influences in particular. In addition, the water-insoluble pigments can now easily be homogeneously dispersed in water owing to their coating.

For optical configuration of coated or painted surfaces, built structures or articles, particularly outdoors, inorganic pigments have been used for decades because they usually have higher stability to UV radiation and weathering effects compared to the group of the organic pigments.

While inorganic pigments composed of metal compounds, for example of lead, cadmium and chromium, were used in the initial stages of colour development, there is currently an increasing desire for alternatives. The driving force for this switch is confirmed findings about risks to health and the environment that are associated with the heavy metal-containing pigments, and these lead, both in the production of the pigments and of the paints comprising them and in the use and disposal thereof, to avoidable stresses in the persons involved and on the environment.

A multitude of different substances are currently finding use as weathering-resistant colour pigments. As well as compounds that have long been known and are used in large volumes, for example iron oxides in various variants and hues, ultramarines and zirconium silicates, pigments based on bismuth and vanadium have also been produced since the 1970s.

These are represented particularly in the colour range from yellow to orange and can thus at least partly replace critical lead chromates and cadmium sulfides.

U.S. Pat. No. 5,851,587A and U.S. Pat. No. 4,115,141A describe the production of such bismuth- and vanadium-based pigments.

However, the use of such pigments is also associated with drawbacks compared to the established pigments composed of cadmium and lead compounds.

For instance, Hugh M. Smith in “High Performance Pigments” is one source that discusses inadequate stability to high pH values of the said pigments composed of bismuth and vanadium.

U.S. Pat. No. 5,976,238A mentions that both bismuth and vanadium in the crystal lattice can be exchanged for other ions.

It has been shown that this ion exchange also takes place under particular conditions with commercial vanadium yellow pigments and there is exchange of colour therewith. In the paints and coatings industries, changes in hue owing to outside influences are fundamentally always undesirable since the hue constitutes an essential and quality-determining feature of a coating.

Bismuth vanadate pigments are insoluble in water and alkali. Unprotected bismuth vanadate pigments in wall paints on highly alkaline substrates such as cement undergo a change in colour as a result of an ion exchange, in that ions migrate from the cement into the pigments and ions are exchanged in lattice positions.

There are a number of methods of producing bismuth- and vanadium-containing pigments having improved stability to outside influences, such as heat, acid and alkalis. U.S. Pat. No. 4,063,956A describes the use of silicon for improving resistance to heat.

U.S. Pat. No. 4,851,049A mentions the use of zirconium-containing coatings on vanadium yellow pigments as a known method of increasing the acid stability of the pigments inter alia.

According to U.S. Pat. No. 4,063,956A, the bismuth vanadate pigments are coated with one or more layers of silicon oxide, aluminium oxide, titanium oxide and boron oxide.

Nevertheless, the stability of the bismuth- and vanadium-containing pigments is an ongoing challenge and is in need of further optimization.

The problem addressed was therefore that of developing a pigment coating that stabilizes the compounds mentioned, especially to high pH values. A further problem addressed was that of providing pigment coatings that confer good water dispersibility on the water-insoluble pigments, in order to assure preferably homogeneous distribution of the coated pigments in water-based paint formulations, coating formulations, etc. A further problem addressed was that of providing biologically compatible pigment coatings from renewable raw materials, which preferably have defined biodegradability, and which impart good ion resistance to bismuth vanadate pigments.

It has been found that, surprisingly, the aforementioned problems are solved by the use of carbohydrate-containing syndets according to claim 1 and by the use according to claim 15. It is possible to produce the bismuth vanadate-containing pigments that have been coated with the carbohydrate-containing syndets by the process according to claim 13. Further configurations and preferred embodiments are disclosed in the dependent claims and also detailed in the description.

The invention therefore provides compositions comprising pigments containing bismuth vanadate (BiVO₄), wherein the bismuth vanadate-containing pigments are in the form of particles coated with O-functionalized carbohydrates or mixtures of O-functionalized carbohydrates, and the O-functionalized carbohydrates are selected from ethers and/or esters of carbohydrates, especially from sugar ethers in which the non-glycosidic OH group(s) has/have been etherified, glycosides and sugar esters. The carbohydrates are selected from monosaccharides, oligosaccharides, sugar alcohols, sugar acids and lactones of the sugar acids. The oligosaccharides are selected from oligosaccharides having two to ten monosaccharides; the oligosaccharides preferably have 2 to 6 monosaccharides.

The O-functionalized carbohydrates are also referred to in the present case as syndets or carbohydrate-containing syndets. In the ether and/or ester O-functionalized carbohydrates according to the invention, the ether or ester group forms the aglycone and the carbohydrate residue—the glycone. The glycone, i.e. the carbohydrate residue of the O-functionalized carbohydrates, is hydrophilic and preferably water-soluble, whereas the ether or ester groups are preferably hydrophobic. Methods of preparing the ether and/or ester O-functionalized carbohydrates are disclosed inter alia in U.S. Pat. No. 4,297,290A, U.S. Pat. No. 3,021,324A and WO01/46375A1.

According to a preferred embodiment, preference is given to compositions in which a) the ethers of the O-functionalized carbohydrates are selected from ethers of aliphatic alcohols having 1 to 36 carbon atoms, especially saturated or unsaturated aliphatic, linear, branched or cyclic alcohols having 1 to 36 carbon atoms, especially having 1 to 20 carbon atoms. The aliphatic alcohols may comprise an alkyl, alkenyl or alkynyl group having 1 to 36 carbon atoms, especially having 1 to 20 carbon atoms. Preference is given to at least one O-alkyl-functionalized carbohydrate, preferably selected from O-alkyl-functionalized monosaccharides, O-alkyl-functionalized oligosacchandes, where the alkyl group has 1 to 36 carbon atoms, especially 1 to 20 carbon atoms, which may be linear, branched or cyclic. Preference is given to monoalcohols.

Preference is likewise given, in one embodiment, to compositions in which

b) the esters of the O-functionalized carbohydrates are selected from esters of aliphatic carboxylic acids having 1 to 36 carbon atoms, preference being given to saturated or unsaturated, aliphatic, linear, branched or cyclic carboxylic acids having 1 to 36 carbon atoms. Particular preference is given to saturated or unsaturated carboxylic acids having 1 to 20 carbon atoms. In a particularly preferred alternative, the O-functionalized carbohydrates are selected from O-acyl-functionalized carbohydrates which are preferably selected from O-acyl-functionalized monosaccharides, O-acyl-functionalized oligosaccharides. Linear, branched or cyclic saturated acyl groups having 1 to 36 carbon atoms are preferred, more preferably 1 to 20 carbon atoms. Likewise preferred are carbohydrates having mixed functionalization, such as c) ethers and esters of O-functionalized carbohydrates of the aliphatic alcohols and aliphatic carboxylic acids having 1 to 36 carbon atoms mentioned under a) and b). The carboxylic acids may include omega-alicyclic fatty acids. Preference is given to monocarboxylic acids.

In particularly preferred variants, the O-functionalized carbohydrates are prepared from carbohydrates and aliphatic alcohols having 1 to 36 carbon atoms, especially monoalcohols. Preferred aliphatic alcohols having 1 to 36 carbon atoms are selected from linear fatty alcohols, branched fatty alcohols, unsaturated fatty alcohols, preferably from monounsaturated fatty alcohols and polyunsaturated fatty alcohols. The esters of the O-functionalized carbohydrate are preferably selected from fatty acids, preferably mono fatty acids, more preferably from linear fatty acids, branched fatty acids, unsaturated fatty acids, preferably monounsaturated fatty acids, polyunsaturated fatty acids.

The carbohydrates usable in accordance with the invention for preparation of the 0-functionalized carbohydrates or the carbohydrates that are in the form of the O-functionalized residue with elimination of a water molecule from the —OH groups in the carbohydrate and the aliphatic alcohol or the aliphatic carboxylic acid are as follows: (i) monosaccharides including aldoses such as aldobioses, aldotrioses, aidotetroses, aldopentoses, aidohexoses, ketoses such as ketotriose, ketotetroses, ketopentoses, ketohexoses, cyclic hemiacetals and/or cyclic hemiketals, such as, in particular, D-/L-gyceraidehyde, D-L-erythrose, D-/L-threose, L-arabinose, D-ribose, D-xylose, D-lyxose, D-glucose, L-glucose, D-mannose. L-mannose, D-galactose, L-galactose, D-fructose, L-fructose, D-allose, D-altrose, D-idose, D-talose, D-erythrulose, D-ribuose, D-xylulose, D-psicose, D-sorbose, D-tagatose, and cyclic monosaccharides including α-D-glucose, β-D-glucose, α-D-fructopyranose, β-D-fructopyranose. β-D-glucopyranose, β-D-mannopyranose, α-D-galactopyranose, D-thyminose, L-rhamnose, digitoxose, D-digitalose, D-cymarose, L-oleandrose,

(ii) oligosaccharides including disaccharides, trisaccharides, tetrasaccharides, pentasaccharides, hexasaccharides, heptasaccharides, octasaccharides, nonasaccharides and decasaccharides, preference being given to di- to hexasaccharides, particular preference to di- to tetrasaccharides,
(iii) sugar alcohols including D-sorbitol, D-mannitol, dulcitol,
(iv) sugar acids including D-gluconic acid, D-saccharic acid, D-mannosaccharic acid, mucic acid, D-gluconic acids, and the corresponding lactones of the sugar acids mentioned.

Specifically preferred O-functionalized carbohydrates are selected from aliphatic alkyl O-sugar ethers having 1 to 36 carbon atoms in the alkyl group, such as ethers on the non-glycosidic OH group or else ethers on the glycosidic OH group, glycosides having 1 to 36 carbon atoms in the alkyl group, sugar esters having 1 to 36 carbon atoms in the acyl group and mixtures of the aforementioned compounds. Preference is given in accordance with the invention to O-functionalized carbohydrates selected from alkyl O-D-glucopyranosides having 1 to 36 carbon atoms in the alkyl group, especially having 4 to 20 carbon atoms in the alkyl group. Particular preference is likewise given to alkyl-D-glucopyranosides having 8 to 10 carbon atoms in the alkyl group, or alkyl-D-glucopyranosides having 10 to 16 carbon atoms in the alkyl group, such as decyl-D-glucopyranoside, octyl-D-glucopyranoside. Preferred sugar ethers, especially on a non-glycosidic OH group, as glycosides and sugar esters are those of monosaccharides and disaccharides and mixtures of the aforementioned compounds. Frequently, the aforementioned compounds are also referred to as alkyl polyglucosides.

It is likewise possible for glucosides, mannosides, fructosides, furanosides, pyranosides, such as methyl-α-D- or methyl-β-D-glucopyranoside, methyl-α-D- or methyl-β-D-glucofuranoside, methyl-α-D- or methyl-β-D-fructofuranoside, ethyl-α-D-glucopyranoside or ethyl-β-D-glucopyranoside, to be present in the composition as O-functional carbohydrates for coating bismuth vanadate-containing pigments.

The glycosidic bond refers to the chemical bond between the anomeric carbon atom of a carbohydrate (glycone) and the heteroatom or, less commonly, the carbon atom of an aglycone or a second sugar molecule. Glycosides (glycosidic bond between glycone and aglycone) are widespread in nature. When the aglycone is an alcohol, the bridging oxygen atom comes from the aglycone.

Particularly preferred compositions comprise ethers selected from glycosidic monosaccharides and glycosidic oligosaccharides, preferably from glycosidic disaccharides, fructosidic monosaccharides, which are preferably in the form of O-glycosides of alcohols, especially of fatty alcohols.

Particularly preferred coatings of bismuth vanadate-containing pigments are O-functionalized carbohydrates including (i) cetearyl glucosides, ethylhexyl glucosides, methylglucose isostearate, cetyl glucoside, stearyl glucoside, caprylyl glucoside, lauryl glucoside, cacryl glucosides, myristyl glucosides, decyl glucosides, cocoglucosides (alkyl polyglucosides based on coconut oil and glucose) and/or

(ii) sorbitan laurate, sorbitan stearate, sorbitan tristearate, sorbitan laurate, sorbitan sesquicaprylate, sucrose stearate.

The content of the O-functionalized carbohydrate or the mixture thereof in the composition of the coated particulate bismuth vanadate-containing pigments is preferably from 0.05% to 50% by weight and the content of bismuth vanadate from 99.95% to 50% by weight in the overall composition, preference being given to 10% to 30% by weight of O-functionalized carbohydrate to 90% to 70% by weight of bismuth vanadate, particular preference to 20% to 30% by weight of O-functionalized carbohydrate to 80% to 70% by weight of bismuth vanadate. Preferably, the compositions comprise 25% by weight of O-functionalized carbohydrate to 75% by weight of bismuth vanadate, in each case independently plus/minus 2% by weight. The O-functional carbohydrates here form a coating around the bismuth vanadate-containing particulate pigments.

Fatty alcohols include 1-hexanol, 1-heptanol, 1-octanol, 1-decanol, 1-dodecanol (lauryl alcohol), 1-tetradecanol (myristyl alcohol), 1-hexadecanol (cetyl alcohol), 1-heptadecanol (margaryl alcohol), 1-octadecanol (stearyl alcohol), 1-eicosanol (arachidyl alcohol), 1-docosanol (behenyl alcohol), 1-tetracosanol (lignoceryl alcohol), 1-hexacosanol (ceryl alcohol), 1-octacosanol (montanyl alcohol), 1-triacontanol (melissyl alcohol), cis-9-hexadecen-1-ol (palmitoleyl alcohol), cis-9-octadecen-1-ol (oleyl alcohol), trans-9-octadecen-1-ol (elaidyl alcohol), cis-11-octadecen-1-ol, cis,cis-9,12-octadecadien-1-ol (linoleyl alcohol), 6,9,12-octadecatrien-1-ol (γ-linolenyl alcohol).

Fatty acids include formic acid, acetic acid, butyric acid, isobutanoic acid, valeric acid, isovaleric acid, caproic acid, oenanthic acid, caprylic acid, 2-ethylcaproic acid, pelargonic acid, capric acid, lauric acid, myristic acid, myristoleic acid, palmitic acid, palmitoleic acid, stearic acid, oleic acid, elaidic acid, ricidnoleic acid, linoleic acid, linolenic acid, elaeostearic acid, arachic acid, behenic acid or erucic acid.

In addition, preference is given to a composition comprising water-soluble O-functionalized carbohydrates or mixtures of O-functionalized carbohydrates in the form of a coating of bismuth vanadate-containing pigments. A water-soluble O-functionalized carbohydrate is considered to be one having a solubility of not less than 100 g to not more than 1500 g/l in water at 20° C., preferably of not less than 500 g to not more than 1200 g/l at 20° C.

The composition comprising pigments containing bismuth vanadate (BiVO₄) that have been coated with O-functionalized carbohydrates or mixtures of pigments coated with O-functionalized carbohydrates has particularly good dispersibility in water or else water-containing mixtures with other solvents, as shown in FIG. 2b.

The O-functional carbohydrates, synonymous here with syndets, include the reaction products of:

A) one or more carbohydrates of the empirical formula (I)

CₙH₂ₙOₙ with n=1 to 36 (I)

B) one or more fatty alcohol(s) of the general formula
(II), (III) or (IV): CₙH₂ₙ₊₁OH (II), or CₙH₂ₙ₋₁OH (III), or CₙH₂ₙ₋₅OH (IV); each with n=1 to 36 carbon atoms, preferably 1 to 20 carbon atoms, attached covalently to the aforementioned carbohydrate via an ether bond.
A) preferably includes a compound from the monosaccharides, bioses or alditols, and B) is preferably a linear or branched, saturated or mono- to polyunsaturated fatty alcohol.

Examples of such compounds can be found in U.S. Pat. No. 4,297,290 A. U.S. Pat. No. 3,021,324 A and WO2001046375 A1. The O-functional carbohydrates for production of the coating of the particulate pigments may be in a formulation supported, for example, on zeolites, or in the form of a formulation optionally containing further additives.

A particularly preferred embodiment of the present invention comprises O-functional carbohydrates having at least one or more than one aliphatic alkyl or acyl group, preferably each having 1 to 34 carbon atoms, preferably one or more identical alkyl or acyl groups in each case or mixtures of different groups and a carbohydrate radical consisting of mono- or disaccharides, for example glycose, fructose, galactose, sucrose, lactose or maltose, or mixtures thereof.

The ratio of the ether or ester group of the aliphatic alcohols or the aliphatic carboxylic acids to the carbohydrate residue is preferably in the range from 90:10 to 10:90, preferably from 30:70 to 70:30, in parts by weight, more preferably in the range from 40:60 to 60:40.

The molar ratio of the ether or ester group of the aliphatic alcohols or the aliphatic carboxylic acids to the carbohydrate residue is preferably in the range from 0.3:1 to 3:1, preferably 1:1, preferably in each case independently plus/minus 0.5, preferably plus/minus 0.15.

Particular preference is given to 0-functionalized carbohydrates capable of setting the L* value of the L+a*b* values according to the CIE-Lab system of the bismuth vanadate-containing pigments coated with O-functionalized carbohydrates within the range of not more than 76, preferably not more than 72, more preferably not more than 70, not more than 67.

The invention likewise provides a composition comprising bismuth vanadate-containing pigments in the form of particles coated with O-functionalized carbohydrates or mixtures of O-functionalized carbohydrates, wherein

a) the difference (dL) in the L value by the CIE-Lab system before and after storage of the pigments at 18 to 23° C. over 7 days in an aqueous solution containing alkaline earth metal ions and/or alkali metal ions in the form of a suspension, especially of a 10% by weight aqueous alkaline earth metal ion and/or alkall metal ion solution, preferably in a closed vessel, determined as dL=L (before storage)−L (after storage), has a value of dL=18 to 0, especially of 15 to 0, preferably of 10 to 0, more preferably of 8 to 0, and/or
b) the difference (dL) in the L value by the CIE-Lab system of a dried layer containing the pigments or a layer of the pigments, optionally in a formulation, before and after contact with an aqueous solution containing alkaline earth metal ions and/or alkali metal ions at elevated temperature, especially after contact with a 10% by weight aqueous alkaline earth metal ion and/or alkali metal ion solution for 1 hour, especially at elevated temperature, preferably at about 70 to 80° C., determined as dL=L (before contact)−L (after contact), has a value of dL=18 to 0, especially of 15 to 0, preferably of 10 to 0, more preferably of 8 to 0, and/or c) the difference (dL) in the L value by the CIE-Lab system (i) before and after contact with an aqueous solution containing alkaline earth metal ions and/or alkali metal ions and having a pH of not less than 9, or (ii) before or after storage in the presence of an aqueous solution containing alkaline earth metal ions and/or alkali metal ions and having a pH of not less than 9, determined as (i) dL=L (before contact)−L (after contact), has a value of dL=18 to 0 or (ii) dL=L (before storage)−L (after storage) has a value of dL=18 to 0. Preference is given to values of dL of 15 to 0, preferably 10 to 0, more preferably 8 to 0. The pH is preferably pH=8 to 14, especially not less than 10, preferably not less than 11, more preferably not less than 12, not less than 13, preferably to pH=14.

The invention provides for the inventive use of the O-functionalized carbohydrates or carbohydrate-based syndets as a sheath or coating material for bismuth- and vanadium-containing pigments for increasing stability with respect to an alkaline medium and the foreign ions present therein.

Bismuth- and vanadium-containing pigments may be of any nature, whether in pure form as BiVO₄ or in a modification with at least one further element, for example aluminium, silicon, iron or phosphorus.

The compositions according to the invention, n the form of pigments containing bismuth vanadate (BiVO₄), may optionally additionally contain a content of molybdenum, tungsten, molybdenum oxide, tungsten oxide, aluminium, phosphorus, zirconium and/or iron and mixtures of the aforementioned components.

Further bismuth vanadates that may be coated with the O-functionalized carbohydrates according to the invention are as follows: BiVO₄; Bi₂AO₆ with A=Mo or W, 4BiVO₄.3Bi₂MoO₆, BiVO₄.xBi₂zO₆, z=Mo or W, x=0 to 2.5; BiVO₄.xBi₂MoO₆, x=0.2 to 2.5, BiVO₄.x²Bi₂ MoO₆.yBi₂ WO₆, with x²=0.6 to 2.25 and y=0 to 0.1, Bi[(V_{1-b}bP_{b})O₄] in which b=0 to 0.1, especially with b=0.001 to 0.08, preferably b=0.01 to 0.06; b=0.002 to 0.01, Bi_{c}Fe_{d}EᵥV(1−_{w})P_{w}O_{z} I in which the variables are defined as follows: E is calcium, zinc, cerium, praseodymium and/or silicon, especially zinc, calcium and/or cerium; c=0.8 to 1.2; d>0 to 0.1 when v>0, and is ≥0.035 to 0.1 when v=0: v is ≥0 to 0.2; w is >0 to 0.1; z is the number of oxygen atoms to fulfil the valence requirements of the cations, especially c=0.9 to 1.1; d=0.005 to 0.07; v=0.01 to 0.15; w is >0 to 0.05; where z is the number of oxygen atoms to fulfil the valence requirements of the cations, and generally bismuth vanadate-containing yellow-colouring to orange-colouring pigments.

A classic bismuth vanadate is known by the name C.I. Pigment Yellow 184 and the CAS No. 14059-33-7. Naturally occurring minerals comprising bismuth vanadate are pucherite, clinobisvanite and dreyerdte.

The compositions may, as well as the bismuth vanadate-containing pigments coated with O-functional pigments, additionally contain further pigments and be in the form of a mixture.

Examples include some organic pigments such as Pigment yellow 13, Pigment yellow 14, Pigment yellow 17, Pigment yellow 55, Pigment yellow 83, Pigment orange 34 (3H-pyrazol-3-one, 4,4′-[(3,3′-dichloro[1,1′-biphenyl]-4,4′-diyl)bis(azo)]bis[2,4-dihydro-5-methyl-2-(4-methylphenyl)], (CAS No: 15793-73-4)), Pigment orange 36 (butanamide, 2-[(4-chloro-2-nitrophenyl)azo]-N-(2,3-dihydro-2-oxo-1H-benzimidazol-5-yl)-3-oxo-), Pigment orange 73 (CAS No.: 084632-59-7), Pigment orange 34.

Preference is likewise given to compositions comprising bismuth vanadate (BiVO₄) particles of particulate pigments coated with O-functionalized carbohydrates wherein the pure bismuth vanadate particles, i.e. without coating, have a particle size distribution of d₅₀ not less than 0.1 μm to 10 μm, preferably of 0.1 μm to 5 μm, more preferably of 0.1 μm to 4 μm, particular preference being given to a particle size distribution of d₉₀ not less than 0.1 μm to 10 μm, preferably of 0.1 μm to 5 μm, more preferably of 0.1 μm to 4 μm, particular preference being given to a particle size distribution of d₉₉ not less than 0.1 μm to 10 μm, preferably of 0.1 μm to 5 μm, more preferably of 0.1 μm to 4 μm.

The coating of the pigments with O-functional carbohydrates is effected at least as a monolayer, preferably in multiple layers.

The invention likewise provides a process for producing the composition and a composition obtainable by the process, comprising bismuth vanadate-containing pigments coated with O-functionalized carbohydrates or mixtures of O-functionalized carbohydrates, by mixing, preferably vigorously mixing, O-functionalized carbohydrates or mixtures of O-functionalized carbohydrates selected from ethers and/or esters of carbohydrates, such as sugar ethers, glycosides and/or sugar esters, where the carbohydrates are selected from monosaccharides, oligosaccharides having two to ten monosaccharides, sugar alcohols, sugar acids and lactones of the sugar acids, in the presence of a protic fluid, preferably water, with bismuth vanadate-containing pigments in particulate form. The particle size distribution of the uncoated pigments preferably corresponds to the aforementioned ranges. The mixing is preferably effected at 100 to 10 000 revolutions/minute. Protic fluids also include alcohols or aqueous mixtures with organic solvents.

The invention likewise provides formulations suitable as coating materials comprising a composition according to the invention or a composition obtainable by the process comprising at least one binder, water and optionally additives, solvents and/or pigments. The formulation is preferably a coating slip.

The invention further provides for the use of O-functionalized carbohydrates selected from ethers and/or esters of carbohydrates, and of preferably unsubstituted carbohydrates such as glucose, sorbitol, sucrose or mixtures of these, for coating particulate bismuth vanadate-containing pigments and preferably for protection of the pigments from bleaching, especially by alkaline compounds.

Carbohydrates according to the invention especially include the following: monosaccharides, such as α-D-ribofuranose, β-D-fructofuranose, α-D-mannopyranose, α-L-rhamnopyranose (6-deoxy-α-L-mannopyranose); cellobiose (1-β-D-glucopyranosyl-4-β-D-glucopyranoside), maltose (1-α-D-glucopyranosyl-4-α-D-glucopyranose), glucose, also called grape sugar or less commonly dextrose, mannose, an epimer of glucose, fructose, also called fruit sugar, ribose, part of ribonucleic acid (RNA), deoxyribose, galactose, also called mucus sugar, fucose, an L-sugar, rhamnose, an L-sugar, disaccharides, such as sucrose, also called beet sugar or cane sugar (glucose+fructose), trehalose, lactose, also called milk sugar (glucose+galactose), lactulose, a synthetically modified milk sugar, maltose, also called malt sugar (glucose+glucose), trehalose, a non-reducing sugar (glucose+glucose), triple sugars (trisaccharides), melezitose, trisaccharide, including in honey, raffinose, which remains in the molasses in the refining of sugar, umbelliferose and also α-cyclodextrin.

The protection of the treated pigments relates here to any alkaline medium, as can be brought about by alkali or alkaline earth metal bases or other basic substances. Foreign ions are especially divalent, positively charged ions from the group of the alkaline earth metals, but also metal ions such as zinc, iron or others.

The pigments that have been coated in accordance with the invention and therefore protected are also protected from an alkaline medium in formulations, as in coating materials, printing inks and/or printing varnishes, plastics or the like. The pigments protected in accordance with the invention can therefore also be used in the matrix of plastics or preferably polywood.

Examples of coating materials in the context of the present invention are paints, varnishes, printing inks and other coating materials, such as solventborne coatings and solvent-free coatings, powder coatings, UV-curable coatings, low-solids, medium-solids and high-solids, automotive coatings, wood coatings, baked coatings, 2-component coatings, metal coating materials and toner compositions. Further examples of coating materials are given in “Bodo Müller, Ulrich Poth, Lackformullerung und Lackrezeptur, Lehrbuch fOr Ausbildung und Praxis [Coating Formulation and Coating Composition, Textbook for Training and Practice], Vincentz Verlag, Hanover (2003), 73-287”.

Examples of printing inks and/or printing varnishes in the context of the present invention are solvent-based printing inks, flexographic printing inks, intaglio printing inks, letterpress or relief printing inks, offset printing inks, lithographic printing inks, printing inks for printing of packaging, screenprinting inks, printing inks such as printing inks for inkjet printers, inkjet ink, printing varnishes such as overprint varnishes.

Examples of printing Ink and/or printing varnish formulations are given in “E.W. Flick, Printing Ink and Overprint Varnish Formulations—Recent Developments, Noyes Publications, Park Ridge N.J., (1990). pp. 2-107.

### WORKING EXAMPLES

Substances According to the Invention

TABLE 1

| | Product | INCI (referred to hereinafter as syndet) |
|---|---|---|
| 1 | TEGO Care C 90 | Cetearyl Glucoside |
| 2 | TEGO Tens G 826 | Ethylhexyl Glucoside |
| 3 | TEGO SML | Sorbitan Laurate |
| 8 | TEGO SMS | Sorbitan Stearate |
| 7 | TEGO STS | Sorbitan Tristearate |
| 8 | TEGO Care LTP | Sorbitan Laurate |
| 11 | ISOLAN IS | Methylglucose Isostearate |
| 12 | ANTIL SOFT SC | Sorbitan Sesquicaprylate |
| 13 | TEGO Care SE 121 | Sucrose Stearate |
| 14 | Glucopon ® 425 N | Caprylyl Glucoside |
| 15 | GLUCOPON ® 600 UP | Lauryl Glucoside |
| 16 | Glucopon ® 225 DK | Caprylyl/Capryl Glucoside |
| 17 | GLUCOPON ® 420 UP | Caprylyl Glucoside (and) Myristyl |
| | | Glucoside |
| 18 | Glucopon ® 215 UP | Caprylyl Glucoside (and) Decyl Glucoside |
| 19 | Glucopon ® 650 EC | Coco-Glucoside |
| 20 | | Sucrose |
| 21 | | Methyl glycoside |
| 22 | | Sorbitol |

### Example 1

The substances according to the invention can be applied to the pigment surfaces in various ways. The wetting of the pigments takes place rapidly owing to an affinity, which is known to the person skilled in the art, of the syndets to hydrophobic surfaces, particularly in the presence of water. Mention is made here by way of example of wetting in a dual asymmetric centrifuge; many other standard methods of mixing solids and liquids are possible.

10 g of vanadium yellow (vanadium yellow from Cappelle, Belgium, namely Lysopac Orange 6820B) were mixed with 2.7 g of carbohydrate-based syndet 1 or O-functionalized carbohydrate and 2 g of water in a dual asymmetric centrifuge (Hauschild DAC 150 FVZ) at 2500 rpm for 3 min. The resultant heat of friction and associated reduction in viscosity of the carbohydrate-based syndet promotes the mixing process. The moist mixture was freed of water at 60° C. in a standard air circulation oven for 16 h. As the last step, the modified vanadium yellow was ground in a blade mill (Retsch Grindomix GM200) at 10 000 rpm for 10 seconds.

### Examples 2 to 22

Example 1 was repeated using the reactants listed in Table 2.

TABLE 2

| | | | Amount [g] of | | |
|---|---|---|---|---|---|
| | | | vanadium | | Weight |
| | | Amount [g] | yellow | Amount [g] | ratio |
| Ex. | CBS¹ | of CBS¹ | (VDY) | of water | CBS:VDY |
| 1 | 1 | 2.7 | 10 | 2 | 21.2:78.8 |
| 2 | 2 | 2.7 | 10 | 2 | 21.2:78.8 |
| 3 | 3 | 2.7 | 10 | 2 | 21.2:78.8 |
| 6 | 6 | 2.7 | 10 | 2 | 21.2:78.8 |
| 7 | 7 | 2.7 | 10 | 2 | 21.2:78.8 |
| 8 | 8 | 2.7 | 10 | 2 | 21.2:78.8 |
| 11 | 11 | 2.7 | 10 | 2 | 21.2:78.8 |
| 12 | 12 | 2.7 | 10 | 2 | 21.2:78.8 |
| 13 | 13 | 2.7 | 10 | 2 | 21.2:78.8 |
| 14 | 14 | 2.7 | 10 | 2 | 21.2:78.8 |
| 15 | 15 | 2.7 | 10 | 2 | 21.2:78.8 |
| 16 | 16 | 2.7 | 10 | 2 | 21.2:78.8 |
| 17 | 17 | 2.7 | 10 | 2 | 21.2:78.8 |
| 18 | 18 | 2.7 | 10 | 2 | 21.2:78.8 |
| 19 | 19 | 2.7 | 10 | 2 | 21.2:78.8 |
| 20 | 20 | 2.7 | 10 | 2 | 21.2:78.8 |
| 21 | 21 | 2.7 | 10 | 2 | 21.2:78.8 |
| 22 | 22 | 2.7 | 10 | 2 | 21.2:78.8 |

¹carbohydrate-based syndet (CBS)

### Non-Inventive Comparative Examples

As comparative example C1, commercially available vanadium yellow from Cappelle, Belgium, namely Lysopac Orange 68208 (uncoated vanadium yellow) is used. Comparative example C2 is a vanadium yellow protected by a noninventive method, Lysopac Orange 6821B (C2 has an inorganic coating).

### Application Examples

Testing Procedure:

The vanadium yellow pigments that have been coated with carbohydrate-based syndets, i.e. O-functionalized carbohydrates, were suspended in 10% sodium hydroxide solution.

Since the vanadium yellow pigments having non-inventive modification show a certain resistance to pure sodium hydroxide solution, but not to foreign cations (particularly of main group 2), in alkaline solution, typical fillers were added to the test mixture. Table 3 lists the fillers used.

The ratio of vanadium yellow pigment to filler/NaOH solution (10%) was kept constant in all experiments (1:1:15).

TABLE 3
Fillers

| Raw material | Composition |
|---|---|
| Millicarb OG | CaCO₃ |
| Blance fixe micro | BaSO4 |
| Mondo Finntalc M10E SQ | Mg₃Si₄O₁₀(OH)₂ |
| Quarzwerke Tremin 939-100 | Ca₃[Si₃O₉] |
| ESST ground wollastonite | |
| Norzinco Harzsiegel Standard zinc white | ZnO |

Production:

The formulation constituents are weighed out in transparent 20 ml screw top bottles according to the above formulations and homogenized on a neoLab tumbling/rolling mixer for 5 minutes. The samples are then stored at room temperature.

Test Methods:

In order to assess the performance of the carbohydrate-based syndets, the colour strength obtained was measured after storage at room temperature (in a closed vessel) for one week.

Colorimetry:

The colour of the reaction mixture was measured with an X-Rite instrument (model: X-Rite SP 60). In order to be able to detect the colour values, the reaction mixtures had to be photographed in order then to be able to undertake measurements on the printed images. For this purpose, it was necessary to define the photography and printing conditions. The photographs were taken from the side, in an illuminated fume hood as far away as possible from daylight windows. Photographs were taken with a PRAKTIKA LM16-Z24S in the “flower” imaging mode. The images were printed in unprocessed form on a SHARP MX-2640N PCL6 in standard quality.

The values known as the L*a*b* values according to the CIE-Lab system (CIE=Commission Intemationale de l'Eclairage) were determined for all samples. The CIE-Lab system is useful as a three-dimensional system for quantitative description of the colour loci. In this system, the colours green (negative a* values) and red (positive a* values) are plotted on one axis, and the colours blue (negative b* values) and yellow (positive b* values) on the axis arranged at right angles thereto. The value C* is formed from a* and b* as follows: C*=(a*2+b*2)0.5 and is used to describe violet color loci. The two axes cross at the achromatic point. The vertical axis (achromatic axis) is crucial for the brightness, varying from white (L=100) to black (L=0). The CIE-Lab system can be used to describe not just colour loci but also colour separations via the specification of the three coordinates.

TABLE 4
Comparison of conventional vanadium yellow, vanadium
yellow treated in a non-inventive manner (Comparative
Examples C1 and C2) and vanadium yellow pretreated
in accordance with the invention (CBS 1 to 22).

| Carbohydrate-based syndet | L after | L before | |
|---|---|---|---|
| (CBS) | storage | storage | dL |
| 1 | 73.55 | 60.23 | 13.32 |
| 2 | 70.03 | 60.99 | 9.04 |
| 3 | 76.71 | 60 | 16.71 |
| 6 | 70.83 | 60.14 | 10.69 |
| 7 | 68.56 | 60.24 | 8.32 |
| 8 | 71.93 | 59.97 | 11.96 |
| 11 | 70.14 | 60.6 | 9.54 |
| 12 | 68.35 | 59.69 | 8.66 |
| 13 | 71.48 | 60.15 | 11.33 |
| 14 | 63.9 | 60.94 | 2.96 |
| 15 | 65.5 | 60.38 | 5.12 |
| 16 | 64.59 | 59.96 | 4.63 |
| 17 | 62.65 | 59.8 | 2.85 |
| 18 | 61.09 | 60.37 | 0.72 |
| 19 | 61.23 | 60.01 | 1.22 |
| 20 | 71.02 | 59.64 | 11.38 |
| 21 | 72.72 | 60.08 | 12.64 |
| 22 | 75.54 | 60.97 | 14.57 |
| C 1 | 83.11 | 60.33 | 22.78 |
| C 2 | 81.05 | 60.15 | 20.90 |

Colour Measurements on the Carbohydrate-Based Syndets of Examples 1 to 22:

What are desired here are low L* values (brightness values), which show maintenance of the orange hue of the solid constituents of the reaction mixture, i.e. the bismuth vanadate-containing pigments coated with O-functionalized carbohydrates, in the presence of aqueous 10% by weight NaOH solution. It is found that the carbohydrate-based syndets used in accordance with the invention, as compared with the non-inventive comparative examples, assure lower L* values and hence higher hue stability, recognizable by the lower dL=L before test−L after test.

### Application Examples

In addition, the pigments according to the invention comprising carbohydrate-based syndets 1 to 22 from Table 2 were tested with the non-inventive comparative examples in a commercial exterior facade paint.

The retention of hue after exposure to hot sodium hydroxide solution (10% NaOH in water) on the finished coating surface is assessed by the method described in the examples above, the hue measurement method (L value).

TABLE 5
Formulation of the white exterior wall paint

| Raw material | Percent by weight % | Description |
|---|---|---|
| Deionized water | 33.05 | |
| Tego Foamex 855 | 0.20 | Defoamer |
| ACTICIDE MBS | 0.15 | Biocide |
| CALGON N new | 0.05 | Water softener |
| TEGO Dispers 715 W | 0.30 | Dispersing additive |
| AMP-90 | 0.10 | 2-Amino-2-methyl-1- |
| | | propanol |
| KRONOS 2310 | 12.5 | TiO₂ |
| SOCAL P 3 | 10.00 | CaCO₃ |
| OMYACARB 5 GU | 15.00 | CaCO₃ |
| OMYACARB 2 GU | 10.00 | CaCO₃ |
| MICA TG | 3.00 | Muscovite: K Al₂ |
| | | [AlSi₃O₁₀(OH)₂] |
| SIPERNAT 820 A | 2.00 | SiO₂ |
| DOWANOL DPnB | 1.00 | Solvent |
| ACRONAL S 790 | 12.00 | Binder |
| RHEOLATE 278 | 0.65 | Rheology additive |
| TOTAL | 100.00 | |

The foreign ions that have been added in Examples 23-40 of Table 6 in the form of fillers that are typical of coatings are present in homogeneous distribution in the coating formulation in this example.

To this mixture are added 5 g of vanadium yellow pigment or 5+X g, i.e. 5 g*0.1% to 100%, X=0.0005 to 5 g, of the pigments treated in accordance with the invention, where X is the amount of the carbohydrate-containing syndet used for protection, and this is stirred in at a shear rate of 10 m/s by means of a DISPERMAT CV from Getzmann for 10 minutes. The 150 μm system applied by means of a coating bar is dried at room temperature over 7 days.

To test the bismuth and vanadium pigment-containing coatings for hue stability to alkaline medium and foreign ions, a 10% by weight sodium hydroxide solution was made up. This was heated to 80° C., and 5 ml of the hot sodium hydroxide solution in each case were dripped onto the horizontal, fully dried coating. The liquid is to be applied to the coating such that it comes to rest on the coating as a coherent accumulation without dividing. In order to minimize concentration of the sodium hydroxide solution as a result of evaporation, a vessel matched to the volume of the sodium hydroxide solution is directly placed over the alkali.

The process is set up in the same way for all samples and the duration of exposure for 60 minutes is observed accurately.

Thereafter, the sodium hydroxide solution is washed off the coating completely with a jet of cold water.

The evaluation is effected by the method described in Examples 23-40, directly on the exposed, fully dried location in the coating.

As has already become clear in Table 4, the compounds according to the invention have a noticeably different profile of properties compared to the non-inventive comparative examples, in such a way that the hue after exposure, as apparent from Table 6, is maintained only with pigments treated in accordance with the invention.

TABLE 6
Inventive CBS use examples and use examples
of Comparative Examples C1 and C2

| | Carbohydrate-based | L | L | |
|---|---|---|---|---|
| | syndet | after | before | |
| Example | (CBS) | contact | contact | dL |
| 23 | 1 | 71.88 | 59.64 | 12.24 |
| 24 | 2 | 71.22 | 59.12 | 12.10 |
| 25 | 3 | 75.99 | 60.01 | 15.98 |
| 28 | 6 | 70.65 | 60.25 | 10.40 |
| 29 | 7 | 68.37 | 60.41 | 7.96 |
| 30 | 8 | 71.66 | 59.99 | 11.67 |
| 33 | 11 | 69.36 | 60.49 | 8.87 |
| 34 | 12 | 68.79 | 58.56 | 10.23 |
| 35 | 13 | 71.04 | 59.87 | 11.17 |
| 36 | 14 | 63.12 | 59.31 | 3.81 |
| 37 | 15 | 65.98 | 60.1 | 5.88 |
| 34 | 16 | 64.1 | 59.27 | 4.83 |
| 35 | 17 | 62.01 | 60.07 | 1.94 |
| 36 | 18 | 61.88 | 60.58 | 1.30 |
| 37 | 19 | 60.99 | 59.89 | 1.10 |
| 38 | 20 | 71.52 | 60.2 | 11.32 |
| 39 | 21 | 71.22 | 59.5 | 11.72 |
| 40 | 22 | 75 | 59.66 | 15.34 |
| Comparative Example | C 1 | 83.99 | 59.38 | 24.61 |
| Comparative Example | C 2 | 80.44 | 59.77 | 20.67 |

The above experiments demonstrate the efficacy of the O-functional carbohydrates as a protective coating for bismuth vanadate-containing particulate pigments with respect to bleaching in the presence of alkali metal and/or alkaline earth metal. On the basis of the above measurement results, it is found that the alkyl-O-functional carbohydrates, especially the glycosides of fatty alcohols, with L* values of 60.99 to 65.98, enable particularly high colour stability of the treated pigments. But the sorbitan esters of fatty acids as acyl-O-functional carbohydrates also show good L* values in the range from 68.35 to 71.93, a good colour stability of the treated pigments.

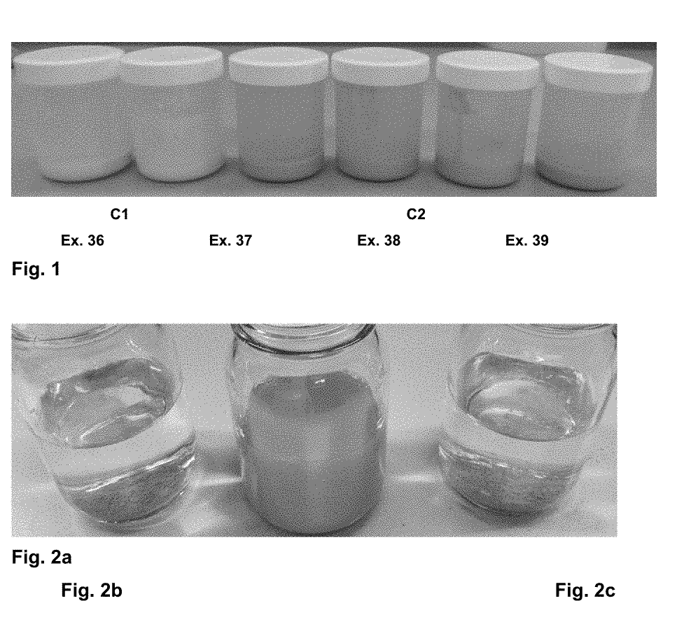

FIG. 1 shows a visualization of the measurement results from Examples 36, 37, 38 and 39 compared to the results of the application-oriented Comparative Examples 1 and 2 from Table 6.

The different behaviour of the bismuth vanadate pigments from CE 1, and from a mixture that has been coated in accordance with the invention and a physical mixture with O-functional carbohydrates, in water, Is shown in FIGS. 2a, 2b and 2c. FIG. 2a shows the behaviour of the unmodified bismuth vanadate pigments from CE 1 in water, which precipitate out as an insoluble deposit. FIG. 2c shows a purely physical mixture of the pigments and the O-functionalized carbohydrates in water without coating of the pigments with the O-functionalized carbohydrates. The homogeneous distribution of the water-soluble bismuth vanadate pigments coated in accordance with the invention with the O-functionalized carbohydrates (syndet:pigment, 21.2% by weight to 78.8% by weight) in water is very clearly apparent in FIG. 2b.

1: A composition, comprising:
a pigment comprising bismuth vanadate (BiVO₄),
wherein the pigment is in the form of particles coated with at least one O-functionalized carbohydrate,
wherein the O-functionalized carbohydrate is at least one member selected from the group consisting of an ether of a carbohydrate and an ester of a carbohydrate,
wherein the carbohydrate is at least one member selected from the group consisting of a monosaccharide and an oligosaccharide, and
wherein the oligosaccharide is at least one member selected from the group consisting of an oligosaccharide having two to ten monosaccharides, a sugar alcohol, a sugar acid, and a lactone of the sugar acid.

2: The composition according to claim 1, wherein
a) the ether of the O-functionalized carbohydrate is selected from the group consisting of ethers of aliphatic alcohols having 1 to 36 carbon atoms,
b) the ester of the O-functionalized carbohydrate is selected from the group consisting of esters of aliphatic carboxylic acids having 1 to 36 carbon atoms.

3: The composition according to claim 2, wherein
a) the aliphatic alcohol having 1 to 36 carbon atoms is at least one member selected from the group consisting of a linear fatty alcohol, a branched fatty alcohol, and an unsaturated fatty alcohol, and
b) the aliphatic carboxylic acid having 1 to 36 carbon atoms is at least one member selected from the group consisting of a linear fatty acid, a branched fatty acid, and an unsaturated fatty acid.

4: The composition according to claim 1, wherein
(i) the monosaccharide is at least one member selected from the group consisting of an aldose, a ketose, a cyclic hemiacetal, and a cyclic hemiketal
(ii) the oligosaccharide is at least one member selected from the group consisting of a disaccharide, a trisaccharide, a tetrasaccharide, a pentasaccharide, a hexasaccharide, a heptasaccharide, an octasaccharide, a nonasaccharide, and a decasaccharide,
(iii) the sugar alcohol is at least one member selected from the group consisting of D-sorbitol, D-mannitol, and dulcitol, and
(iv) the sugar acid is at least one member selected from the group consisting of D-gluconic acid, D-saccharic acid, D-mannosaccharic acid, mucic acid, D-gluconic acids, and a lactone thereof.

5: The composition according to claim 1, wherein
the O-functionalized carbohydrate is at least one member selected from the group consisting of an aliphatic alkyl O-sugar ether having 1 to 36 carbon atoms in the alkyl group, a glycoside having 1 to 36 carbon atoms in the alkyl group, a sugar ester having 1 to 36 carbon atoms in the acyl group.

6: The composition according to claim 1, wherein
the O-functionalized carbohydrate is at least one alkyl O-glucopyranoside having 1 to 36 carbon atoms in the alkyl group.

7: The composition according to claim 1, wherein
the O-functionalized carbohydrate is at least one alkyl O-D-glucopyranoside of a linear or branched fatty alcohol.

8: The composition according to claim 1, wherein
the ether of a carbohydrate is at least one member selected from group consisting of a glycosidic monosaccharide and a glycosidic oligosaccharide.

9: The composition according to claim 1, wherein the pigment further comprises
at least one member selected from the group consisting of molybdenum oxide, tungsten oxide, aluminium, phosphorus, zirconium, and iron.

10: The composition according to claim 1, wherein the pigment is
in the form of particles having a particle size distribution, d₅₀, of not less than 0.1 μm to 10 μm.

11: The composition according to claim 1, wherein
the O-functionalized carbohydrate comprises at least one member selected from the group consisting of a cetearyl glucoside; an ethylhexyl glucoside; methylglucose isostearate; cetyl glucoside; stearyl glucoside; caprylyl glucoside; lauryl glucoside; a cacryl glucoside; a myristyl glucoside; a decyl glucoside; a cocoglucoside, which is an alkyl polyglucoside based on coconut oil and glucose, sorbitan laurate; sorbitan stearate; sorbitan tristearate; sorbitan laurate; sorbitan sesquicaprylate; sucrose stearate.

12: The composition according to claim 1, wherein
the pigments in the form of particles coated with at least one O-functionalized carbohydrate,
the composition has a content of 0.05% to 50% by weight of the at least one O-functionalized carbohydrate and
the composition has a content of 99.95% to 50% by weight of the pigment in the overall composition.

13: The composition according to claim 1, wherein
the pigment in the form of particles coated with the at least one O-functionalized carbohydrate, and
a) the difference (dL) in the L value by the CIE-Lab system before and after storage of the pigments at 18 to 23° C. over 7 days in an aqueous solution containing alkaline earth metal ions and/or alkali metal ions in the form of a suspension, determined as dL=L (before storage)−L (after storage), has a value of dL=18 to 0, and/or
b) the difference (dL) in the L value by the CIE-Lab system of a dried layer of the pigments before and after contact with an aqueous solution containing alkaline earth metal ions and/or alkali metal ions at elevated temperature, determined as dL=L (before contact)−L (after contact), has a value of dL=18 to 0, and/or
c) the difference (dL) in the L value by the CIE-Lab system before and after contact with an aqueous solution containing alkaline earth metal ions and/or alkali metal ions and having a pH of not less than 9, determined as dL=L (before contact)−L (after contact), has a value of dL=18 to 0.

14: A process for producing the composition according to claim 1, the process comprising:
mixing, in the presence of a protic fluid, a pigment that comprises bismuth vanadate and is in particulate form with at least one O-functionalized carbohydrate selected from the group consisting of an ether of a carbohydrate and an ester of a carbohydrate,
wherein the carbohydrate is at least one member selected from the group consisting of a monosaccharide, an oligosaccharide having two to ten monosaccharides, a sugar alcohol, a sugar acid, and a lactone of the sugar acid.

15: A formulation, comprising:
a composition according to claim 1,
a binder,
water, and
optionally at least one of an additive and a further pigment.

16. (canceled)
